(19) United States
(12) Patent Application Publication
(10) Pub. No.: US 2026/0333031 A1
(43) Pub. Date: Oct. 22, 2026

(54) SEAMLESS ROAMING EXCHANGE WITH NEXT PAIRWISE MASTER KEY IDENTIFIER

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/468,725

(22) Filed: Feb. 3, 2026

Related U.S. Application Data
(60) Provisional application No. 63/754,455, filed on Feb. 5, 2025.

(51) Int. Cl. H04W 12/0431; H04W 12/03; H04W 36/00; H04W 36/18

(52) U.S. Cl. CPC H04W 12/0431; H04W 12/03; H04W 36/0016; H04W 36/18

(57) ABSTRACT

The present disclosure describes a network that provides a next pairwise master key identifier (PMKID) when roaming. According to an embodiment, a first wireless access point includes one or more memories and one or more processors communicatively coupled to the one or more memories. The one or more processors, individually or collectively, perform an operation that includes receiving, from a first device, a first message indicating that the first device is roaming to the first wireless access point. The first message includes a first pairwise PMKID. The operation also includes retrieving a pairwise transient key (PTK) for the first device based on the first PMKID and communicating, to the first device, a second message comprising a second PMKID different from the first PMKID.

### CROSS-REFERENCE TO RELATED APPLICATIONS

This application claims benefit of co-pending United States provisional patent application Serial No. 63/754,455 filed Feb. 5, 2025. The aforementioned related patent application is herein incorporated by reference in its entirety.

### TECHNICAL FIELD

Embodiments presented in this disclosure generally relate to seamless roaming. More specifically, embodiments disclosed herein relate to providing a next pairwise master key identifier (PMKID) during roaming.

### BACKGROUND

Wireless devices (e.g., Wi-Fi devices) may use seamless roaming to quickly roam between access points in a seamless mobility domain. The wireless devices and access points may use PMKIDs to perform roams. In some systems, the wireless devices may rotate or change media access control (MAC) addresses when roaming. As a result, in these systems, the wireless devices and the access points may use the PMKIDs of the wireless devices to identify the devices (e.g., rather than the MAC addresses). Using the PMKIDs to identify the wireless devices, however, may introduce security vulnerabilities or privacy issues.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network controller, access point, or device in the system of FIG. 1A.

FIG. 2 illustrates an example operation performed by the system of FIG. 1A.

FIG. 3A illustrates an example operation performed by the system of FIG. 1A.

FIG. 3B illustrates an example operation performed by the system of FIG. 1A.

FIG. 4 illustrates an example operation performed by the system of FIG. 1A.

FIG. 5 illustrates an example operation performed by the system of FIG. 1A.

FIG. 6 illustrates an example operation performed by the system of FIG. 1A.

FIG. 7 illustrates an example operation performed by the system of FIG. 1A.

FIG. 8 is a flowchart of an example method performed by the system of FIG. 1A.

FIG. 9 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a network that provides a next PMKID when roaming. According to an embodiment, a first wireless access point includes one or more memories and one or more processors communicatively coupled to the one or more memories. The one or more processors, individually or collectively, perform an operation that includes receiving, from a first device, a first message indicating that the first device is roaming to the first wireless access point. The first message includes a first pairwise PMKID. The operation also includes retrieving a pairwise transient key (PTK) for the first device based on the first PMKID and communicating, to the first device, a second message that includes a second PMKID different from the first PMKID.

According to another embodiment, a method includes receiving, at a first wireless access point and from a first device, a first message indicating that the first device is roaming to the first wireless access point. The first message includes a first PMKID. The method also includes retrieving a PTK for the first device based on the first PMKID and communicating, to the first device, a second message that includes a second PMKID different from the first PMKID.

According to another embodiment, a device includes one or more memories and one or more processors communicatively coupled to the one or more memories. The one or more processors, individually or collectively, perform an operation that includes receiving, from a first wireless access point, a first PMKID, based on determining that the device should roam from the first wireless access point to a second wireless access point, communicating a roaming request to the second wireless access point that includes the first PMKID, receiving, from the second wireless access point, a roaming response that includes a second PMKID different from the first PMKID, and based on determining that the device should roam from the second wireless access point to a third wireless access point, communicating to the third wireless access point, a roaming request that includes the second PMKID.

### EXAMPLE EMBODIMENTS

The present disclosure describes a network that provides, to a wireless device when the wireless device initiates a roam, a pairwise master key identifier (PMKID) that the wireless device may use to initiate a subsequent roam. Generally, when a wireless device (which may also be referred to as a non-access point (AP) multi-link device (MLD)) requests to roam to a first access point (which also be referred as an AP MLD), the wireless device may provide the first access point a PMKID. When the first access point responds, the first access point may provide the wireless device a new PMKID. The wireless device may use the new PMKID when roaming away from the first access point to a second access point (e.g., in the same seamless mobility domain (SMD)). For example, the wireless device may provide the new PMKID to the second access point to initiate the roam. Additionally, the second access point may provide the wireless device another new PMKID that the wireless device may later use to roam away from the second access point and to a third access point.

In certain embodiments, the network provides several technical advantages. For example, the network may improve security and privacy for a wireless device by providing new PMKIDs for the wireless device to use when the wireless device roams in the network. As a result, the wireless device may be identified by a PMKID that rotates or changes when the wireless device roams.

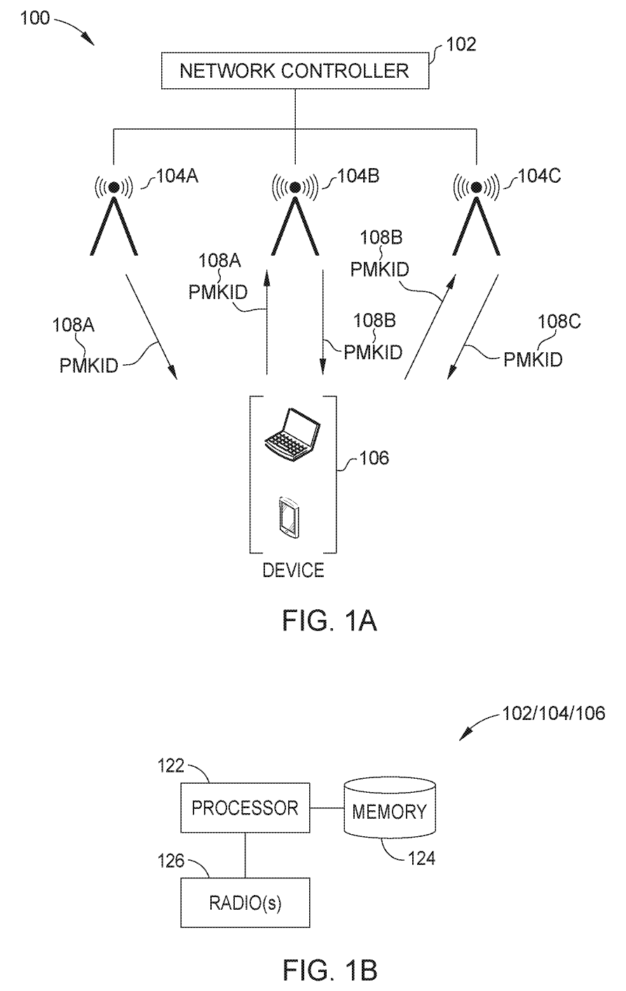

FIG. 1A illustrates an example system 100. As seen in FIG. 1A, the system 100 includes a network controller 102, one or more access points 104 (e.g., access points 104A, 104B, and 104C), and one or more devices 106. The access points 104 may belong to a seamless mobility domain (SMD). Initially, when the device 106 associates with the SMD through an access point 104 (e.g., which may also be referred to as the SMD management entity (SMD-ME) in the SMD), then the device 106 receives a PMKID from the access point 104 through which the device 106 is performing association. This PMKID is provided as part of the association process (e.g., it can be provided in the (Re)Association response frame which could be encrypted or can be provided in a secure manner during a 4-way handshake exchange between the access point 104 and the device 106 (e.g., in Message 1 or Message 3 of the 4-way handshake). In one case, the access point 104 and device 106 generate the same PMKID (using a common PMK) as part of the authentication and association procedure with the SMD, and then both sides have a common PMKID to be used for a future roam. The device 106 may use the PMKID when initiating a subsequent roam to another access point 104 (e.g. send the PMKID to the access point 104 in a roaming request frame). The access point 104 to which the device roams provides an updated PMKID as part of the roaming exchange (e.g. in a roaming response frame), for use by the device 106 for a future roam. The roaming request frame may be a ultra-high reliability (UHR) Link Reconfiguration Request frame. A Link Reconfiguration Request frame and the roaming response frame may be a UHR Link Reconfiguration Response frame or a Link Reconfiguration Response frame.

The network controller 102 facilitates or manages the communication in the system 100. As an example, the network controller 102 may determine when the device 106 is roaming to different access points 104. In some instances, the network controller 102 may determine to which access point 104 the device 106 should roam. The network controller 102 may also track and manage the connections and traffic at each access point 104 by controlling which access points 104 receive connections from which devices 106.

The access point 104 may be a network device that facilitates wireless communication (e.g., Wi-Fi communication) in the system 100. In the example of FIG. 1, the system 100 includes an access point 104A, an access point 104B, and an access point 104C. These access points 104 may be part of the same SMD. The device 106 may perform association with the SMD through one of the access points 104, and then the device 106 can perform seamless roaming across these access points 104 in the SMD. The device 106 connects to the access point 104A, and the access point 104A may facilitate communication to and from the device 106. For example, the access point bA may receive messages from the device 106 and direct those messages towards their destination. As another example, the access point 104A may receive messages intended for the device 106 and direct those messages to the device 106. The access point 104A may also exchange messages with the network controller 102 or with the access points 104B and 104C.

The device 106 is any suitable device for communicating with components of the system 100. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment. The device 106 may include a hardware processor, memory, or circuitry configured to perform any of the functions or actions of the device 106 described herein. For example, a software application designed using software code may be stored in the memory and executed by the processor to perform the functions of the device 106.

The device 106 may roam between the access points 104 in the system 100. For example, the device 106 may move around the system 100. As a result, the device 106 may move closer to some access points 104 and further away from other access points 104. As a result, the network controller 102, the access points 104, or the device 106 may determine that the device 106 would be better served by a different access point 104 due to the proximity to that access point 104. In response, the device 106 may roam to that access point 104 and begin communicating with that access point 104.

In the example operation of FIG. 1A, the access points 104A, 104B, and 104C belong to an SMD. The device 106 may perform a process to associate with the SMD through access point 104A and then the device 106 may perform a process to roam between the access points 104A, 104B, and 104C. For example, the device 106 initially associates to the SMD through the access point 104A. The access point 104A may provide the device 106 with a PMKID 108A during association or the same PMKID 108A may be generated both at the AP and the device. The access point 104A may use the PMKID 108A to identify a security association (e.g., a pairwise master key security association (PMKSA), a pairwise transient key security association (PTKSA), etc.) for the device 106. The access point 104A may retrieve a pairwise transient key (PTK) for the device 106 using the PMKID 108A. The access point 104A may then use the PTK to communicate with the device 106 (e.g., to encrypt or decrypt communications with the device 106).

When the device 106 requests to roam to the access point 104B, the device 106 may communicate the PMKID 108A to the access point 104B (e.g. in a roaming request frame). In response, the access point 104B may communicate a message (e.g. a roaming response frame) to the device 106 that includes a PMKID 108B different from the PMKID 108A. The device 106 may store the PMKID 108B, and the device 106 may communicate the PMKID 108B to the access point 104C when the device 106 roams to the access point 104C. In the example of FIG. 1A, when the network controller 102, access point 104B, or device 106 determines that the device 106 should roam away from the access point 104A and to the access point 104B (e.g., due to movement of the device 106), the device 106 may communicate a message to the access point 104B to initiate or indicate the roam. The message may include the PMKID 108A that the access point 104A had previously provided to the device 106. The access point 104B may then retrieve a PTK (and PMKSA) for the device 106, and the access point 104B may use the PTK to communicate with the device 106. Additionally, the access point 104B may provide the device 106 the PMKID 108B (e.g., different from the PMKID 108A) that the device 106 may use to roam away from the access point 104B to another access point. In some embodiments, the PMKID 108B may be randomized.

When the network controller 102, access point 104C, or the device 106 determines that the device 106 should roam away from the access point 104B and to the access point 104C, the device 106 may communicate a message to the access point 104C to initiate or indicate the roam (e.g. a roaming request). The message may include the PMKID 108B that the access point 104B had previously provided to the device 106. The access point 104C may then retrieve a PTK for the device 106 based on the received PMKID 108B, and the access point 104C may use the PTK to communicate with the device 106. Additionally, the access point 104C may provide the device 106 the PMKID 108C (e.g., different from the PMKIDs 108A and 108B) that the device 106 may use to roam away from the access point 104C and to another access point. In some embodiments, the PMKID 108C may be randomized.

In this manner, the system 100 provides a process by which the device 106 does not reuse PMKIDs across roams. The device 106 may use a new PMKID at each roam, which may improve the security and privacy of the device 106 in certain embodiments.

FIG. 1B illustrates an example network controller 102, access point 104, or device 106 in the system 100 of FIG. 1A. As seen in FIG. 1B, the network controller 102, access point 104, or device 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), or state machines, that communicatively couples to the memory 124 and controls the operation of the network controller 102, access point 104, or device 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, access point 104, or device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, access point 104, or device 106 may use one or more of the radios 126 for Wi-Fi communications. The network controller 102, access point 104, or device 106 may use one or more of the radios 126 to transmit messages and one or more of the radios 126 to receive messages. The network controller 102, access point 104, or device 106 may include any number of radios 126 to communicate using any number of communication technologies.

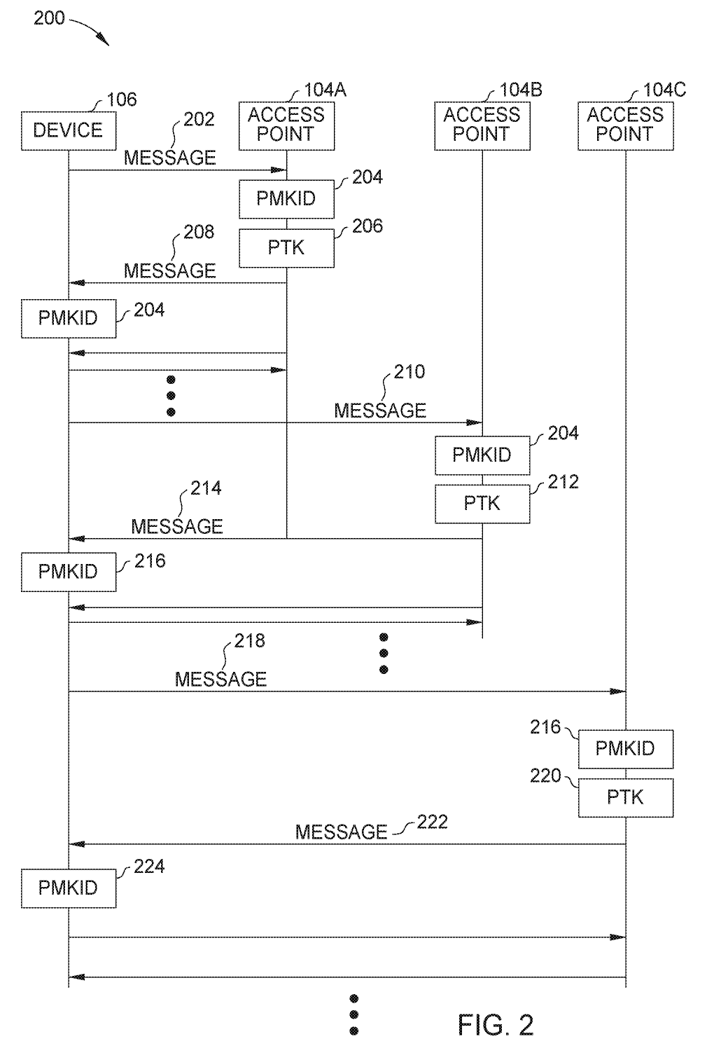

FIG. 2 illustrates an example operation 200 performed by the system 100 of FIG. 1A. As seen in FIG. 2, the device 106, access point 104A, access point 104B, and access point 104C perform the operation 200. Generally, the access points 104A, 104B, and 104C may provide the device 106 PMKIDs when the device 106 roams to these access points 104A, 104B, and 104C. The device 106 may use the PMKIDs to roam away from the access points 104A, 104B, and 104C and to other access points.

The device 106 begins by communicating a message 202 to the access point 104A to associate with the SMD through the access point 104A. The access point 104A may generate or retrieve a PMKID 204 and a PTK 206 for the device 106 (or a security association for the device 106). The access point 104A may communicate a message 208 to the device 106 to complete the association. The message 208 may include the PMKID 204. The PMKID 204 may be provided as part of a 4-way handshake or the same PMKID 204 may be generated by the access point and the device as part of authentication and association procedure. The device 106 and the access point 104A may then communicate with each other using the PTK 206 (e.g., decrypting and encrypting messages from each other using the PTK 206).

At a later time, the device 106 may initiate a roam away from the access point 104A to the access point 104B (e.g., due to movement of the device 106). The device 106 may communicate a message 210 (e.g., a roaming request) to the access point 104B. The message 210 may include the PMKID 204 that the access point 104A previously provided the device 106. The access point 104B may retrieve the PMKID 204 from the message 210 and determine a security association with the device 106 using the PMKID 204. The access point 104B may also retrieve a PTK 212 for the device 106 using the PMKID 204. The PTK 212 may be the same as or different from the PTK 206. To complete the roam, the access point 104B may communicate a message 214 (e.g., a roaming response) to the device 106. The message 214 may include a PMKID 216 different from the PMKID 204. The device 106 may receive and store the PMKID 216 so that the device 106 may use the PMKID 216 to roam away from the access point 104B and to another access point. The device 106 and the access point 104B may then communicate with each other using the PTK 212 (e.g., decrypting and encrypting messages from each other using the PTK 212).

The device 106 may subsequently initiate a roam away from the access point 104B to the access point 104C (e.g., due to movement of the device 106). The device 106 may communicate a message 218 to the access point 104C. The message 218 may include the PMKID 216 that the access point 104B previously provided the device 106. The access point 104C may retrieve the PMKID 216 from the message 218 and determine a security association with the device 106 using the PMKID 216. The access point 104C may also retrieve a PTK 220 for the device 106 using the PMKID 216. The PTK 220 may be the same as or different from the PTKs 206 and 212. To complete the roam, the access point 104C may communicate a message 222 to the device 106. The message 214 may include a PMKID 224 different from the PMKIDs 204 and 216. The device 106 may receive and store the PMKID 224 so that the device 106 may use the PMKID 224 to roam away from the access point 104C and to another access point. The device 106 and the access point 104C may then communicate with each other using the PTK 2 220 (e.g., decrypting and encrypting messages from each other using the PTK 220).

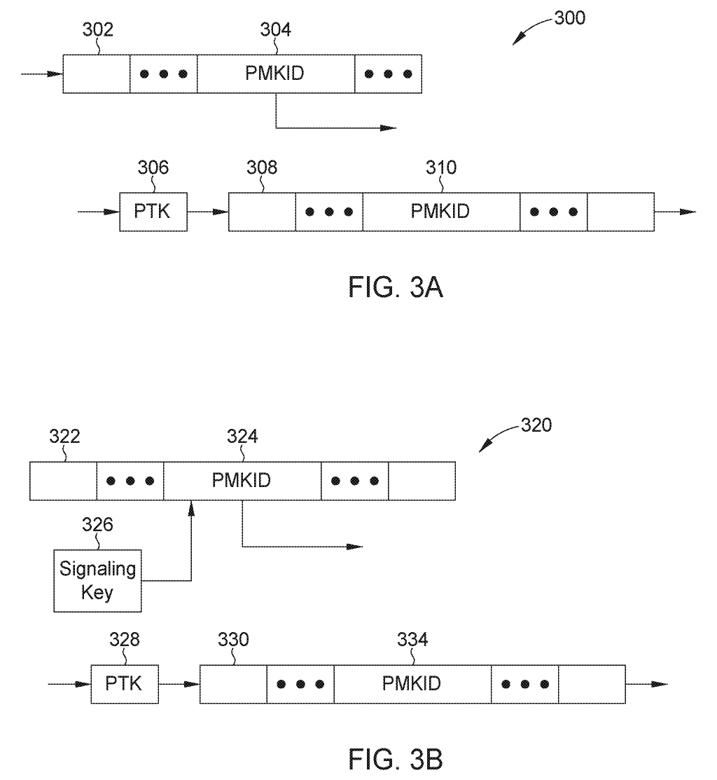

FIG. 3A illustrates an example operation 300 performed by the system 100 of FIG. 1A. Generally, an access point (e.g., an access point 104 shown in FIG. 1A) performs the operation 300. By performing the operation 300, the access point may provide a device a new PMKID when the device roams to the access point.

The access point begins by receiving a message 302 from the device (e.g., a roaming request, a link reconfiguration request frame, a fast transition request frame, a reassociation request frame, a management frame, etc.). The message 302 may indicate that the device is roaming to the access point. As seen in FIG. 3A, the message 302 includes a PMKID 304. The device may have been previously provided the PMKID 304 during a previous roam or when the device authenticated with the system.

The PMKID 304 may be an identifier that identifies a set of keys (e.g., a pairwise master key (PMK), a PTK, etc.) or a security association for the device. The access point may use the PMKID 304 to determine a key for communicating with the device. In the example of FIG. 3A, the access point retrieves a PTK 306 for the device using the PMKID 304. For example, the access point may retrieve the PTK 306 (e.g., from a network controller or key store) using the PMKID 304. In some instances, the access point may determine a security association (e.g., PMKSA) for the device using the PMKID 304. The access point may then retrieve the PTK 306 for the security association. In some embodiments, the access point may retrieve a signaling key based on the PMKID 304 and use the signaling key to process the roaming request.

The access point may then generate and communicate a message 308 (e.g., a roaming response, a link reconfiguration response frame, a fast transition response frame, a reassociation response frame, a management frame, etc.) to the device to respond to the message 302. The message 308 may include a PMKID 310 different from the PMKID 304. For example, the access point may generate a new PMKID 310 for the security association. The access point may then provide the PMKID 310 to the device, so that the device may use the PMKID 310 when the device roams away from the access point to another access point. In this manner, the PMKID 304 is used for one roam (a one-time use PMKID) but not for the subsequent roam, which may improve the security and privacy of the device. The access point may subsequently use the PTK 306 to communicate with the device (e.g., encrypt and decrypt messages using the PTK 306).

In the example of FIG. 3A, the access point may use the PTK 306 to encrypt and decrypt messages to and from the device. For example, the access point may use the PTK 306 to decrypt portions of the message 302. The PMKID 304 may not need to be decrypted using the PTK 306 so that the access point may determine the security association and retrieve the PTK 306 using the PMKID 304. After retrieving the PTK 306, the access point may decrypt other portions of the message 302 using the PTK 306. As another example, the access point may encrypt portions of the message 308 (including or excluding the PMKID 310) using the PTK 306.

In some embodiments, the access point may use information (e.g., information in the message 302) to generate the PMKID 310. For example, access point may hash information (e.g., a PMK for the device, the PTK 306, a media access control (MAC) address for the access point, a MAC address for the device, a roaming sequence number, a nonce value, link identifiers, a MAC address for the SMD, an identifier for the SMD, etc.) to generate the PMKID 310.

FIG. 3B illustrates an example operation 320 performed by the system 100 of FIG. 1A. Generally, an access point (e.g., an access point 104 shown in FIG. 1A) performs the operation 320. By performing the operation 320, the access point may provide a device a new PMKID when the device roams to the access point.

The access point begins by receiving a message 322 from the device (e.g., a roaming request). The message 322 may indicate that the device is roaming to the access point. As seen in FIG. 3B, the message 322 includes a PMKID 324. The device may have been previously provided the PMKID 324 during a previous roam or when the device authenticated and associated with the system.

In the example of FIG. 3B, a portion of the message 322 may have been encrypted using a signaling key 326 established between the access point and the device. The access point may use the PMKID 324 to map to the signaling key 326 and use the signaling key 326 to decrypt the encrypted portion of the message 322. In some instances, the access point may belong to a SMD, and the signaling key 326 is applicable to the access points of the SMD. For example, other access points of the SMD may also use the signaling key 326 to encrypt and decrypt communications with the device.

The signaling key 326 may be generated in any number of ways. For example, the signaling key 326 may be a common key for the SMD that is established based on the common PMK setup with the SMD (at the time of initial association). As another example, the signaling key 326 may be a per-access point key established based on the common PMK setup with the SMD and a MAC address of each access point. As another example, the signaling key 326 may be a common key established based on the first PTK setup with the SMD (at the time of initial association). As another example, the signaling key 326 may be a per-access point key established based on the PTK setup with the SMD and the MAC address of each access point. Other parameters such as a MAC address of the SMD (or a generic SMD Identifier), nonces, and other parameters can be used when generating the signaling key 326. The signaling key 326 may be used for encrypting some parts of the seamless roaming related frames or the complete frames. In one embodiment, the signaling key 326 is stored as part of the PMKSA stored on each access point. In one embodiment, the messages (e.g., roaming request frame, roaming response frame, etc.) are partially encrypted using the authenticated encryption with associated data (AEAD) encryption algorithm. The signaling key 326 may be used for AEAD encryption and may be established at the time of initial association with the SMD.

The PMKID 324 may be an identifier that identifies a set of keys (e.g., a PMK, a PTK, etc.) or a security association for the device. The access point may use the PMKID 324 to determine a key for communicating with the device. In the example of FIG. 3B, the access point retrieves a signaling key 326 and a PTK 328 for the device using the PMKID 324. For example, the access point may retrieve the PTK 328 (e.g., from a network controller or key store) using the PMKID 324. In some instances, the access point may determine a security association (e.g., PMKSA) for the device using the PMKID 324. The access point may then retrieve the PTK 328 for the security association.

The access point may then generate and communicate a message 330 (e.g., a roaming response) to the device to respond to the message 322. The message 330 may include a PMKID 334 different from the PMKID 324. For example, the access point may generate or retrieve the PMKID 334 for the security association. The access point may then provide the PMKID 334 to the device, so that the device may use the PMKID 334 when the device roams away from the access point and to another access point. In this manner, the PMKID 324 is used for one roam but not the subsequent roam, which may improve the security and privacy of the device. The access point may subsequently use the PTK 328 to communicate with the device (e.g., encrypt and decrypt messages using the PTK 328).

In the example of FIG. 3B, the access point may use the PTK 328 to encrypt and decrypt messages to and from the device. For example, the access point may use the PTK 328 to decrypt portions of the message 302. After retrieving the PTK 328, the access point may decrypt other portions of the message 322 using the PTK 328. As another example, the access point may encrypt portions of the message 330 (including or excluding the PMKID 334) using one or more of the PTK 328 or the signaling key 326.

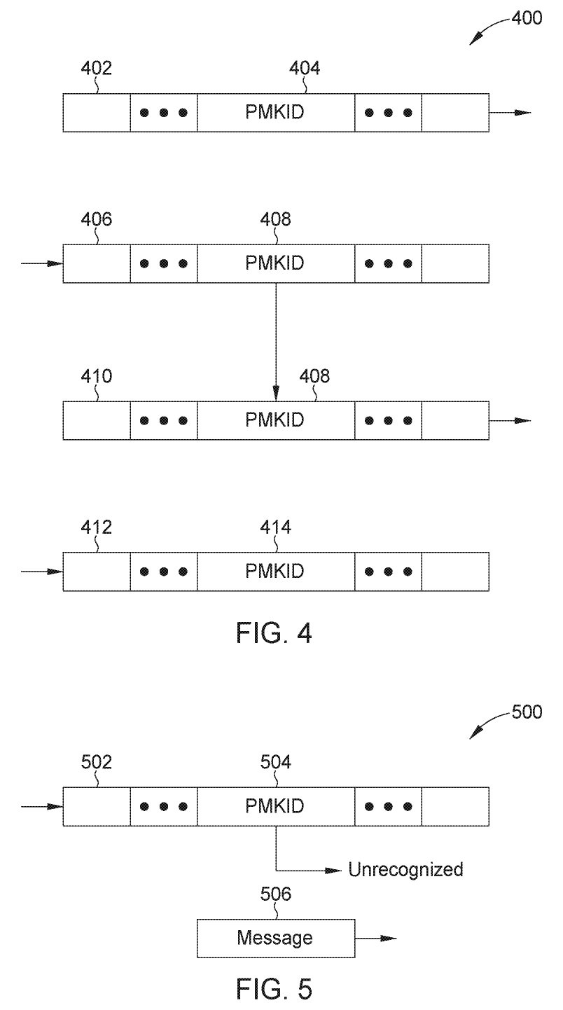

FIG. 4 illustrates an example operation 400 performed by the system 100 of FIG. 1A. Generally, a device (e.g., a device 106 shown in FIG. 1A) performs the operation 400. By performing the operation 400, the device roams to different access points.

The device begins by generating and communicating a message 402 (e.g., a roaming request) to an access point. The message 402 may indicate that the device is roaming to the access point. The message 402 may include a PMKID 404 that indicates a security association for the device and identifies the device. The device may have been previously provided the PMKID 404 during a previous roam or when the device authenticated and associated with the SMD.

The device may receive a message 406 (e.g., a roaming response) from the access point. The message 406 may indicate that the access point has accepted the roam and that the device may begin communicating with the access point. The message 406 may include a PMKID 408 different from the PMKID 404. The access point may provide the PMKID 408 to the device so that the device may use the PMKID 408 to roam away from the access point and to another access point. The PMKID 408 may also identify the security association for the device.

When the device subsequently initiates a roam to another access point, the device may generate a message 410 (e.g., a roaming request) and communicate the message 410 to the other access point. The device may include the PMKID 408 in the message 410 to indicate the security association for the device and an identifier for the device.

The device may receive a message 412 (e.g., a roaming response) from the other access point. The message 412 may indicate that the other access point has accepted the roam and that the device may begin communicating with the other access point. The message 412 may include a PMKID 414 different from the PMKIDs 404 and 408. The other access point may provide the PMKID 414 to the device so that the device may use the PMKID 414 to roam away from the other access point to another access point. The PMKID 414 may also identify the security association for the device. In this manner, the device may be provided a new PMKID each time the device roams to another access point.

FIG. 5 illustrates an example operation 500 performed by the system 100 of FIG. 1A. Generally, an access point (e.g., an access point 104 shown in FIG. 1A) performs the operation 500. By performing the operation 500, the access point may reauthenticate a device when the device provides an unrecognized or incorrect PMKID.

The access point begins by receiving a message 502 (e.g., a roaming request) from a device. The message 502 may indicate that the device is roaming to the access point. As seen in FIG. 5, the message 502 includes a PMKID 504. The device may have been previously provided the PMKID 504 during a previous roam or when the device authenticated with the system.

The access point may analyze the PMKID 504 in the message 502 and determine that the PMKID 504 is unrecognized. For example, the access point may determine that the PMKID 504 does not identify or is not mapped to a known security association. The PMKID 504 may have expired or may have been previously used and is no longer mapped to the security association for the device.

In response, the access point may generate and communicate a message 506 to the device. The message 506 may request that the device reauthenticates and reassociates with the access point or SMD. After receiving the message 506, the device may perform an authentication and association process with the access point or SMD. When the authentication and association process is complete, the access point may allow the device to communicate with the access point. The access point may also provide the device a PMKID different from the PMKID 504. The device may use the PMKID to subsequently roam away from the access point and to another access point.

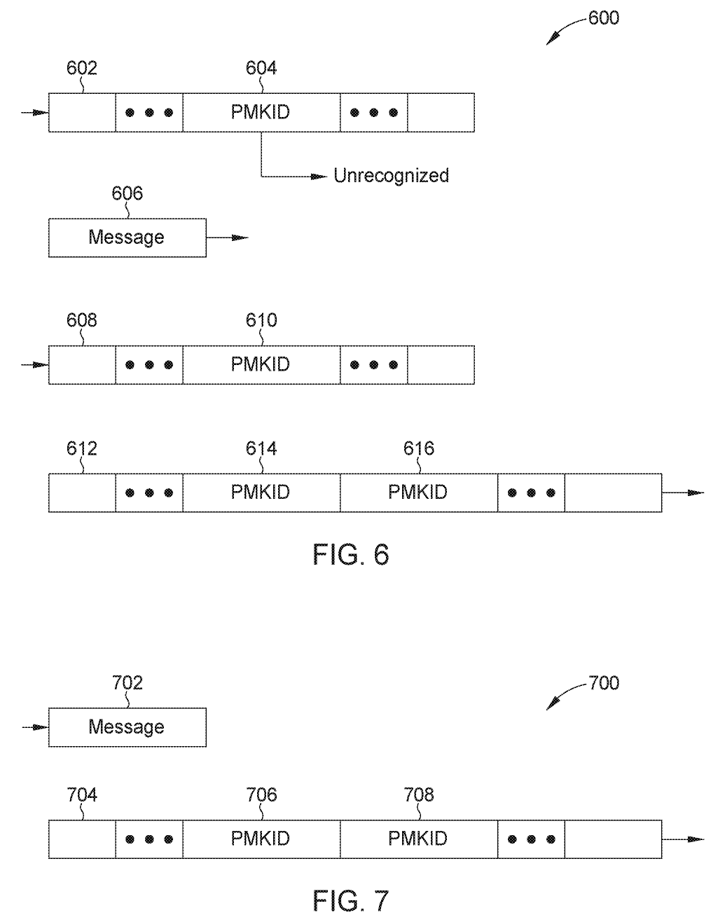

FIG. 6 illustrates an example operation 600 performed by the system 100 of FIG. 1A. Generally, an access point (e.g., an access point 104 shown in FIG. 1A) performs the operation 600. By performing the operation 600, the access point may use multiple PMKIDs for a device.

The access point begins by receiving a message 602 (e.g., a roaming request) from a device. The message 602 may indicate that the device is roaming to the access point. As seen in FIG. 6, the message 602 includes a PMKID 604. The device may have been previously provided the PMKID 604 during a previous roam or when the device authenticated with the system.

The access point may analyze the PMKID 604 in the message 602 and determine that the PMKID 604 is unrecognized. For example, the access point may determine that the PMKID 604 does not identify or is not mapped to a known security association. The PMKID 604 may have expired or may have been previously used and is no longer mapped to the security association for the device. The access point may communicate a message 606 to the device to indicate that the PMKID 604 is unrecognized.

In response to the message 606, the access point may receive a message 608 from the device. The message 608 may include a PMKID 610 different from the PMKID 604. The device may have been previously provided the PMKID 610 during a previous roam or when the device authenticated with the system. The access point may analyze the PMKID 610 and determine that the PMKID 610 does identify or is mapped to the security association for the device.

To complete the roam, the access point may generate and communicate a message 612 to the device. The message 612 may include multiple PMKIDs that the device may subsequently use to initiate roams. In the example of FIG. 6, the message 612 includes a PMKID 614 and a PMKID 616. The PMKIDs 614 and 616 may be different from each other and from the PMKIDs 604 and 610. The device may store the PMKIDs 614 and 616. When the device subsequently initiates a roam away from the access point, the device may provide the PMKID 614 to another access point. If the other access point determines that the PMKID 614 does not identify or is not mapped to the security association for the device, the device may then provide the PMKID 616 to the other access point. In this manner, the access point may provide multiple PMKIDs to the device that the device may use to initiate a roam. The access point may provide multiple PMKIDs to the device in the roaming response in any of the cases covered in previous Figures.

FIG. 7 illustrates an example operation 700 performed by the system of FIG. 1A. Generally, an access point (e.g., an access point 104 shown in FIG. 1A) performs the operation 700. By performing the operation 700, the access point provides one or more PMKIDs to a device during authentication or association.

The access point begins by receiving a message 702 from a device. The message 702 may be communicated as part of an authentication or association process with the device. For example, the message 702 may include identifiers or credentials of the device. As part of authentication, the access point may generate and communicate a message 704 to the device. The message 704 may include one or more PMKIDs along with other information for the device. In the example of FIG. 7, the message 704 includes PMKIDs 706 and 708. The message 704 may include any number of PMKIDs (e.g., one PMKID, two PMKIDs, three PMKIDs, and so on). The device may store the PMKIDs. The device may use the PMKIDs when the device subsequently initiates roams (e.g., away from the access point) to other access points. In the example of FIG. 7, the device may first use the PMKID 706 to initiate a roam. If the PMKID 706 is unrecognized or if the roam fails, the device may then use the PMKID 708 to initiate the roam.

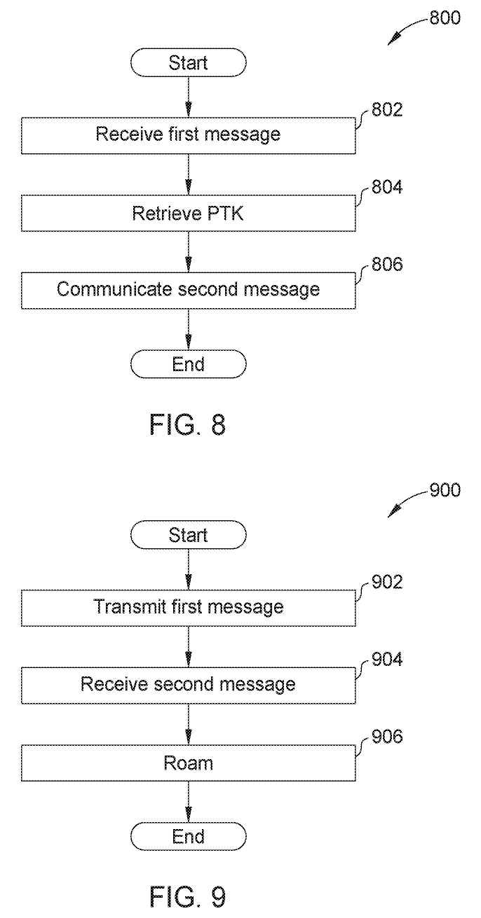

FIG. 8 is a flowchart of an example method 800 performed by the system 100 of FIG. 1A. In certain embodiments, an access point (e.g., the access point 104 shown in FIG. 1A) performs the method 800. By performing the method 800, the access point allows a device to roam to the access point.

At 802, the access point receives a first message (e.g., a roaming request) from a device. The first message may include a PMKID. The device may have previously received the PMKID from another access point in the same SMD as the access point (e.g., due to roaming to the other access point or authenticating and associating with the SMD through the other access point).

At 804, the access point retrieves a PTK for the device using the PMKID. For example, the PMKID may identify or be mapped with a security association for the device. The access point may use the PMKID to identify the security association and to retrieve the PTK for the device (e.g., from a network controller or keystore). The access point may then use the PTK to encrypt and decrypt communications with the device.

At 806, the access point communicates a second message (e.g., a roaming response) to the device. The second message may include a PMKID that is different from the PMKID in the first message. The device may store the PMKID in the second message. The device may use the PMKID in the second message when the device subsequently roams away from the access point and to another access point in the SMD. In this manner, the PMKIDs may be used and rotated when the device roams, which may protect the security and privacy of the device.

FIG. 9 is a flowchart of an example method 900 performed by the system of FIG. 1A. In certain embodiments, a device (e.g., the device 106 shown in FIG. 1A) performs the method 900. By performing the method 900, the device roams to access points in an SMD.

At 902, the device transmits a first message (e.g., a roaming request) to an access point. The first message may include a PMKID. The device may have previously received the PMKID from another access point in the same SMD as the access point (e.g., due to roaming to the other access point or authenticating with the other access point).

At 904, the device receives a second message (e.g., a roaming response) from the access point. The second message may include a PMKID that is different from the PMKID in the first message. The device may store the PMKID in the second message. The device may use the PMKID in the second message when the device subsequently roams away from the access point to another access point.

At 906, the device may roam away from the access point using the PMKID in the second message. For example, the device may transmit a roaming request to another access point, and the roaming request may include the PMKID from the second message.

In summary, the access point 104 provides, to a wireless device 106 when the wireless device initiates a roam, a PMKID that the wireless device 106 may use to initiate a subsequent roam. Generally, when a wireless device 106 requests to roam away from a first access point 104A to a second access point 104B, the second access point 104B may provide the wireless device 106 a new PMKID as part of a roaming response. After the wireless device 106 has roamed to the second access point 104B, the wireless device 106 may use the new PMKID to roam away from the second access point 104B to a third access point 104C.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A first wireless access point comprising:
one or more memories; and
one or more processors communicatively coupled to the one or more memories, the one or more processors configured to, individually or collectively, perform an operation comprising:
receiving, from a first device, a first message indicating that the first device is roaming to the first wireless access point, wherein the first message comprises a first pairwise master key identifier (PMKID);
retrieving a pairwise transient key (PTK) for the first device based on the first PMKID; and
communicating, to the first device, a second message comprising a second PMKID different from the first PMKID.

2. The first wireless access point of claim 1, wherein the first message is a roaming request, and wherein the second message is a roaming response.

3. The first wireless access point of claim 2, wherein a first portion of the roaming request is encrypted and the PTK is used to decrypt and process the roaming request.

4. The first wireless access point of claim 3, wherein a second portion of the roaming request is unencrypted and comprises the first PMKID.

5. The first wireless access point of claim 1, wherein the first PMKID was assigned to the first device by a second wireless access point.

6. The first wireless access point of claim 5, wherein the first wireless access point and the second wireless access point are within a seamless mobility domain (SMD).

7. The first wireless access point of claim 6, wherein the first PMKID was assigned to the first device by the second wireless access point as part of the first device performing association with the SMD through the second wireless access point.

8. The first wireless access point of claim 6, wherein the second PMKID is used by the first device when the first device roams away from the first wireless access point to another wireless access point in the SMD.

9. The first wireless access point of claim 1, wherein the second PMKID is a randomized PMKID for one-time use for a subsequent roam.

10. The first wireless access point of claim 1, wherein the second PMKID is transmitted as encrypted in the second message.

11. The first wireless access point of claim 1, wherein the operation further comprises encrypting, using a signaling key, a portion of the first message or a portion of the second message.

12. The first wireless access point of claim 11, wherein the first wireless access point is part of an SMD, and wherein the signaling key is applicable to access points in the SMD.

13. The first wireless access point of claim 1, wherein the second message indicates a third PMKID different from the first PMKID and the second PMKID.

14. A method comprising:
receiving, at a first wireless access point and from a first device, a first message indicating that the first device is roaming to the first wireless access point, wherein the first message comprises a first PMKID;
retrieving a PTK for the first device based on the first PMKID; and
communicating, to the first device, a second message comprising a second PMKID different from the first PMKID.

15. The method of claim 14, wherein the first message is a roaming request, and wherein the second message is a roaming response.

16. The method of claim 15, wherein a first portion of the roaming request is encrypted and the PTK is used to decrypt and process the roaming request.

17. The method of claim 16, wherein a second portion of the roaming request is unencrypted and comprises the first PMKID.

18. The method of claim 14, wherein the first PMKID was assigned to the first device by a second wireless access point.

19. The method of claim 18, wherein the first wireless access point and the second wireless access point are within a SMD.

20. A device comprising:
one or more memories; and
one or more processors communicatively coupled to the one or more memories, the one or more processors configured to, individually or collectively, perform an operation comprising:
receiving, from a first wireless access point, a first PMKID;
based on determining that the device should roam from the first wireless access point to a second wireless access point, communicating a roaming request to the second wireless access point comprising the first PMKID;
receiving, from the second wireless access point, a roaming response comprising a second PMKID different from the first PMKID; and
based on determining that the device should roam from the second wireless access point to a third wireless access point, communicating to the third wireless access point, a roaming request comprising the second PMKID.
